(19) United States
(12) Patent Application Publication
(10) Pub. No.: US 2022/0159938 A1
(43) Pub. Date: May 26, 2022

(54) Wobbler with a movable place of gravitycenter

(71) Applicant: Osaühing Tarvos Grupp, Parnu (EE)

(72) Inventor: Hans SOLL, Parnu (EE)

(21) Appl. No.: 17/532,325

(22) Filed: Nov. 22, 2021

(30) Foreign Application Priority Data
Nov. 26, 2020 (EE) P202000019

(51) Int. Cl. A01K 85/16

(52) U.S. Cl. CPC A01K 85/16

(57) ABSTRACT

The object of the present invention is a wobbler with adjustable gravity center location having a hollow opening with a threaded sleeve in a casing containing a movable threaded exchangeable additional weight for changing the height of the location of gravity center of the casing relative to its central axis.

### PRIORITY

This application claims priority of Estonian patent application P202000019, which was filed on Nov. 26, 2020 and the contents of which is incorporated herein by reference.

### TECHNICAL FIELD

The invention belongs in the area of lures used in recreational and sport fishing, specifically the area of wobblers the properties of which a fisher can change at the fishing location, more specifically the area of wobblers for which movement properties are changed by changing the height of their gravity center relative to the middle axis of the housing.

### BACKGROUND OF THE INVENTION

Prior art teaches both handmade and industrially made wobblers that differ from one another by dimensions, mass, shape and movement characteristics. Therefore, when a fisher goes on a fishing trip, they have with them several dozens of different wobblers that are expensive to procure. A successfully selected wobbler may also get tangled with plants or other foreign bodies in the water, causing breakage of the fishing line and loss of the wobbler. However, a fisher does not have double supplies, but the wobblers are different from one another. Therefore, there is a need for wobblers the characteristics of which a fisher would be able to change on spot while on a fishing trip. Thus, it is possible to reduce the quantity of wobblers to be taken along, as well as the purchase expenses.

Based on their knowledge, skills and experience, a fisher selects from among the wobblers they have taken along those that are suitable for the type of fish to be caught, the peculiarities of the body of water, weather conditions and time of day. The housings of wobblers are made from floating material. In order to adjust floating properties and change the nature of movement in water, there are many patented solutions where additional weights have been applied to the housing of wobblers for that purpose. An additional weight may be placed either inside or outside the housing, and its mass and location relative to the housing may be changeable. However, both the mass of the additional weight and its location in the housing change the gravity center of the wobbler, causing a change also in its diving properties and the nature of its movement in water.

In the solution based on invention US2003110678 (Yong-Set Bernard, published on Jun. 19, 2003), additional weights have been placed under the wobbler casing and attached to its rod along the longitudinal axis. For invention KR20050056854 (Shimano K K, published on Jun. 16, 2005), the location of the additional weight placed under the casing may be shifted by a threaded adjustment assembly towards the longitudinal axis of the casing. A common drawback of additional weights under the casing is that additional weights placed under the centerline of the casing increase the stability of the wobbler, reducing the wobbly movement of the lure important for fishing.

As for solutions with additional weight placed inside the casing, a device from invention JPH07303436 (Saiga Takashi, published on Nov. 21, 1995) is known with a hollow channel along the axis and a closing cap at the bottom of the casing. A solution based on invention US2007107295 (Kaptis Paul, published on May 17, 2007) is also known where from the lower part of the casing, a hole transversal to the central axis is drilled and a sleeve placed therein closed by a threaded cap. An additional weight has been attached to the cap, and by changing such caps it is possible to change the mass of the casing at the location of fishing, thus changing the floating properties of the wobbler. A common drawback of both solutions is that the location of the drilled hole relative to the central longitudinal axis of the casing has not been determined, as well as the fact that changing of the mass of the additional weight only changes the characteristics of the wobbler to a limited extent, changing mainly its floating properties and not its particular wobbly way of movement depending on the balance conditions.

A device presented in invention U.S. Pat. No. 3,841,012 (Maled C, published on Oct. 15, 1974) is also known, with a micro-engine placed into the wobbler casing, with an eccentric weight on its shaft that makes it move in uniform oscillations. In practice, it turned out that such regularly repeated uniform oscillations do not seem natural to the fish and do not lure them to the hook.

There are also known solutions for changing the oscillating movement of wobbler where the location of the additional weight may be permanently changed relative to the central axis of the casing.

The closest similar invention is the inventor's own earlier patented invention SU1694056 (Solli Hans, published on Nov. 23, 1991). In the hollow casing of the wobbler there is an additional weight attached to the end of a movable threaded rod, and the wobbler's manner of movement is changed by shifting the additional weight horizontally to the central axis of the casing. This solution, however, has an insufficient effect to the movement of the wobbler, as the solution does not significantly impact the balance properties of its casing.

### SUMMARY OF THE INVENTION

The purpose of the present invention is to find a solution where the location of the additional weight impacts the oscillating manner of movement of the wobbler in such a way that it becomes more attractive to the fish to be caught.

According to the solution, the location of the gravity center of the wobbler is changed in vertical direction relative to the central axis of the casing. For that purpose, a hole is drilled to the intended location of the gravity center on the central axis of casing, which may be drilled in the casing from top or bottom, without penetrating it, or penetrating the whole casing.

Balance positions of a body floating in water depend on the height of the gravity center relative to its central axis. If the gravity center is lower than the central axis, the balance position is stable. If the gravity center is at the central axis or near it, the balance position is idle or indifferent. If the gravity center is higher than the central axis, the balance position is unstable. In the event of indifferent and unstable balance positions, the movement of a wobbler is most influenced by deliberate change of winding speed of the fishing line by the fisher, as well as various external factors like the impact of a change in the speed of wind on the fishing line, the impact of different speed of water flow to the wobbler. Besides the amplitude and frequency of oscillation, all such factors also impact other play properties of a wobbler.

The essence of the invention lies in the fact that at the fishing location, relying on their knowledge, skills and experience, the fisher can smoothly shift the height of the gravity center relative to the central axis and thus change the balance properties of the wobbler, choosing an indifferent or unstable balance status. As the movement of a wobbler in water is simultaneously both harmonious oscillation and rotary movement depending on the mass of the casing, a fisher may select a suitable one from the additional weights with different masses they have brought along. Thus: changing both the mass of the additional weight and its height from the central axis of the casing, it is possible to increase the number of play manners of the wobbler.

An additional purpose of the invention was to expand the possibilities of adjustment of the diving position and diving depth of the wobbler. Diving parameters of a wobbler depend on the winding speed of fishing line and the height of the loop for the fishing line on its mirror. For that purpose, the invention prescribes several loops that are located at different heights on the casing, above the central axis. If the winding speed required for the desired diving depth is insufficient, it is possible to select a higher loop for the fishing line.

An additional benefit of the invention is that it is suitable both for handmade and industrially made wobblers that are from different materials, with different size and shape.

### BRIEF DESCRIPTION OF THE DRAWINGS

FIG. 1 shows determination of gravity center longitudinally at the central axis of the casing.

FIG. 2 shows a side view of a wobbler adjustable from above.

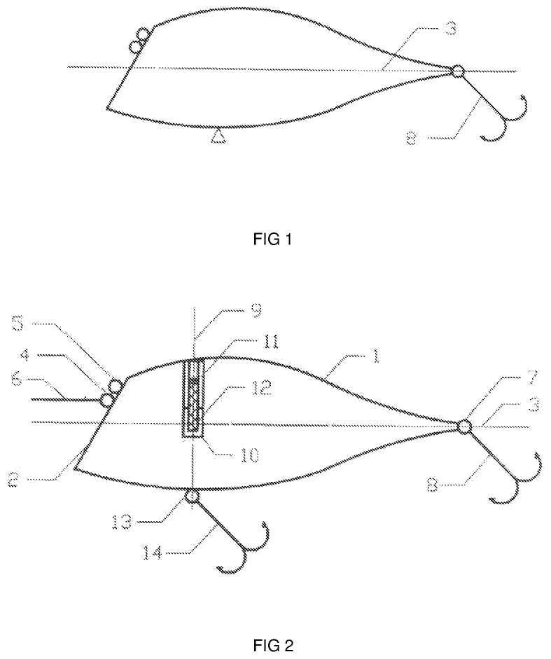

### DETAILED DESCRIPTION OF THE INVENTION

A wobbler with adjustable gravity center location comprises casing 1 that is made from floating material, e.g., wood. The front part of casing 1, mirror 2 in fishing terminology, is a surface that is tilted upwards and to the rear. The tilting angle of mirror 2 is within 40 to 50 degrees from mirror 2 surface and the central axis 3 of the casing 1, based on the desired diving depth. Mirror 2 has loops 4 and 5 for attachment of fishing line 6. Loops 4 and 5 are located on the large half-axis of the ellipse-shaped mirror above its center (above the central axis 3). The lower loop 4 is located at ⅓ and the top loop 5 is located at 2/3 of the distance of the longer half-axis from the center of the ellipse. At the tail of casing 1 there is a loop 7 for attachment of fishing hook 8. Under the belly of the casing 1, on the vertical axis 9, there is a loop 13 for attachment of fishing hook 14.

In preferred embodiment, at the location of the gravity center determined longitudinally on the central axis 3 of the casing 1 loaded with fishing hook 8, a hole 10 towards the vertical axis 9 has been drilled from top with depth 0.65 to 0.75 of the diameter of the casing 1, and a sleeve 11 with inner thread has been placed therein. The hole 10 may be drilled into casing 1 also from the bottom or through the whole diameter of casing 1. In the sleeve 11, there is an additional weight 12 with specific gravity made of material meeting environmental requirements (e.g., stainless steel) that can be shifted by threaded joint, with a recess on the top surface for shifting the weight by an appropriate tool (e.g., an Allen key). By shifting the changeable additional weight 12 also the height of the gravity center of the wobbler relative to the central axis 3 of the casing 1 changes. Depending on the height of the location of the gravity center, the nature of wobbler balance changes.

The additional weight 12 can be exchanged for one from the set of additional weights with different masses that the fisher has with them on the fishing trip, the mass depending on the dimensions of the wobbler itself, being within the limits of 0.2 to 0.25 of the mass of the casing loaded with fishing hooks 8 and 14.

The solution makes it possible for the fisher, relying on their knowledge, skills and experience, to use intermittent winding speed of the fishing line 6 in the event of indifferent and unstable balance position and thereby also change the oscillating movement frequency, amplitude and other play manners of the wobbler. In order to achieve the required diving depth of the wobbler, a fisher may combine the winding speed of fishing line 6 and the height of the loop used for attaching it.

1. A wobbler with adjustable gravity center location with a casing, flat tilted mirror with a lower loop and a top loop for attachment of a fishing line, a tail loop and a belly loop for attachment of fishing hooks, a hole vertically perpendicular to a central axis of the casing, containing a sleeve with inner thread and a movable threaded exchangeable additional weight for changing the location of the gravity center of the casing, wherein the location of the gravity center can be shifted higher than the central axis of the casing.

2. The wobbler with changeable gravity center location according to claim 1, wherein the hole has been drilled in the casing at the location of the gravity center of the casing determined on its central axis.

3. The wobbler with changeable gravity center location according to claim 1, wherein the hole has been drilled in the casing from the top.

4. The wobbler with changeable gravity center location according to claim 1, wherein the hole has been drilled in the casing from the bottom.

5. The wobbler with changeable gravity center location according to claim 1, wherein the hole has been drilled in the casing with a depth of 0.65 to 0.75 of the diameter of the casing when measured at location of the hole.

6. The wobbler with changeable gravity center location according to claim 1, wherein the hole has been drilled through the casing.

7. The wobbler with changeable gravity center location according to claim 1, wherein the mirror has a lower loop and a top loop at different heights above the central axis for attachment of fishing line.
